(19) United States
(12) Patent Application Publication
(10) Pub. No.: US 2026/0046662 A1
(43) Pub. Date: Feb. 12, 2026

(54) ACCURACY INDICATION FOR REFERENCE CHANNEL STATE INFORMATION

(71) Applicant: QUALCOMM Incorporated, San Diego, CA (US)

(72) Inventors: Jay Kumar SUNDARARAJAN, San Diego, CA (US); Taesang YOO, San Diego, CA (US); Chenxi HAO, Beijing (CN)

(21) Appl. No.: 19/102,171

(22) PCT Filed: Nov. 4, 2022
(86) PCT No.: PCT/CN2022/130010

§ 371 Date: Feb. 7, 2025

(51) Int. Cl. H04W 24/10; H04B 7/06

(52) U.S. Cl. CPC H04W 24/10; H04B 7/0626

(57) ABSTRACT

Various aspects of the present disclosure generally relate to wireless communication. In some aspects, a user equipment (UE) may generate a report that includes a reference channel state information (CSI) and an indication of an accuracy of the reference CSI. The UE may transmit the report. Numerous other aspects are described.

### FIELD OF THE DISCLOSURE

Aspects of the present disclosure generally relate to wireless communication and to techniques and apparatuses for indicating an accuracy of a reference channel station information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include generating a first report that includes channel state information (CSI) feedback derived using a machine learning (ML) model under test. The method may include generating a report that includes a reference CSI and an indication of an accuracy of the reference CSI. The method may include transmitting the first report and the second report.

Some aspects described herein relate to a method of wireless communication performed by a network entity. The method may include receiving a first report that includes CSI feedback derived using an ML model under test. The method may include receiving a second report that includes a reference CSI and an indication of an accuracy of the reference CSI. The method may include using the reference CSI for ML model monitoring based at least in part on the accuracy of the reference CSI.

Some aspects described herein relate to a UE for wireless communication. The UE may include a memory and one or more processors coupled to the memory. The one or more processors may be configured to generate a first report that includes CSI feedback derived using an ML model under test. The one or more processors may be configured to generate a report that includes a reference CSI and an indication of an accuracy of the reference CSI. The one or more processors may be configured to transmit the first report and the second report.

Some aspects described herein relate to a network entity for wireless communication. The network entity may include a memory and one or more processors coupled to the memory. The one or more processors may be configured to receive a first report that includes CSI feedback derived using an ML model under test. The one or more processors may be configured to receive a second report that includes a reference CSI and an indication of an accuracy of the reference CSI. The one or more processors may be configured to use the reference CSI for ML model monitoring based at least in part on the accuracy of the reference CSI.

Some aspects described herein relate to a non-transitory computer-readable medium that stores a set of instructions for wireless communication by a UE. The set of instructions, when executed by one or more processors of the UE, may cause the UE to generate a first report that includes CSI feedback derived using an ML model under test. The set of instructions, when executed by one or more processors of the UE, may cause the UE to generate a second report that includes a reference CSI and an indication of an accuracy of the reference CSI. The set of instructions, when executed by one or more processors of the UE, may cause the UE to transmit the first report and the second report.

Some aspects described herein relate to a non-transitory computer-readable medium that stores a set of instructions for wireless communication by a network entity. The set of instructions, when executed by one or more processors of the network entity, may cause the network entity to receive a first report that includes CSI feedback derived using an ML model under test. The set of instructions, when executed by one or more processors of the network entity, may cause the network entity to receive a second report that includes a reference CSI and an indication of an accuracy of the reference CSI. The set of instructions, when executed by one or more processors of the network entity, may cause the network entity to use the reference CSI for ML model monitoring based at least in part on the accuracy of the reference CSI.

Some aspects described herein relate to an apparatus for wireless communication. The apparatus may include means for generating a first report that includes CSI feedback derived using an ML model under test. The apparatus may include means for generating a second report that includes a reference CSI and an indication of an accuracy of the reference CSI. The apparatus may include means for transmitting the first report and the second report.

Some aspects described herein relate to an apparatus for wireless communication. The apparatus may include means for receiving a first report that includes CSI feedback derived using an ML model under test. The apparatus may include means for receiving a second report that includes a reference CSI and an indication of an accuracy of the reference CSI. The apparatus may include means for using the reference CSI for ML model monitoring based at least in part on the accuracy of the reference CSI.

Aspects generally include a method, apparatus, system, computer program product, non-transitory computer-readable medium, UE, mobile station, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example architecture for performance monitoring of machine learning models, in accordance with the present disclosure.

FIG. 6 is a diagram illustrating an example of channel state information (CSI) compression and reconstruction models, in accordance with the present disclosure.

FIG. 7 is a diagram illustrating an example associated with indicating an accuracy of a reference CSI, in accordance with the present disclosure.

FIG. 8 is a diagram illustrating an example of precoding vector similarities, in accordance with the present disclosure.

FIG. 9 is a diagram illustrating an example process performed, for example, by a UE, in accordance with the present disclosure.

FIG. 10 is a diagram illustrating an example process performed, for example, by a network entity, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

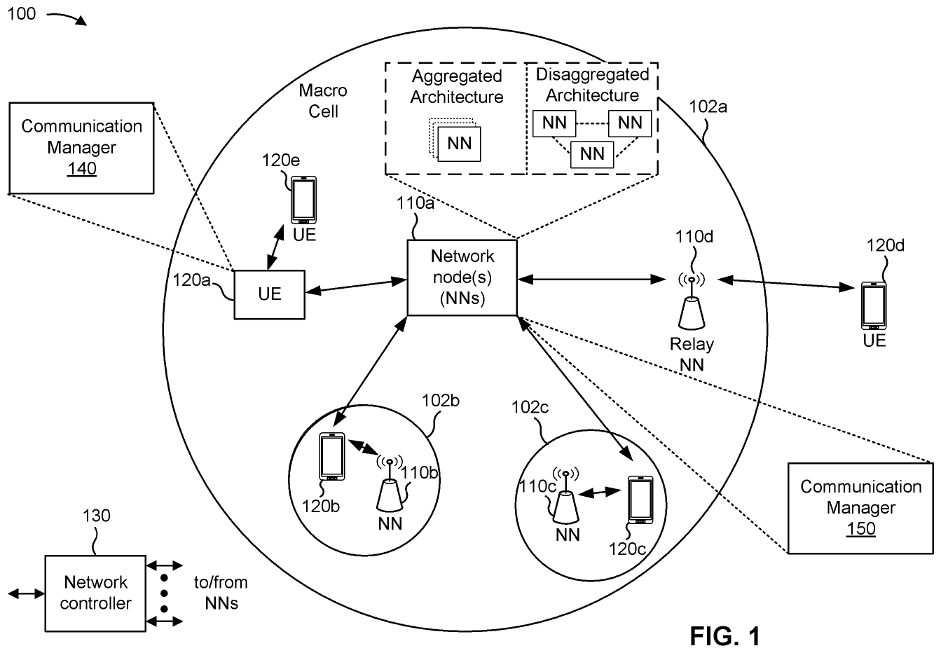

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmit receive point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station,” “network node,” or “network entity” may refer to one device configured to perform one or more functions, such as those described herein in connection with the network node 110. In some aspects, the terms “base station,” “network node,” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station,” “network node,” or “network entity” may refer to any one or more of those different devices. In some aspects, the terms “base station,” “network node,” or “network entity” may refer to one or more virtual base stations or one or more virtual base station functions. For example, in some aspects, two or more base station functions may be instantiated on a single device. In some aspects, the terms “base station,” “network node,” or “network entity” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may generate a first report that includes channel state information (CSI) feedback derived using a machine learning (ML) model under test. The communication manager 140 may generate a second report that includes a reference CSI and an indication of an accuracy of the reference CSI. The communication manager 140 may transmit the first report and the second report. Additionally, or alternatively, the communication manager 140 may perform one or more other operations described herein.

In some aspects, a network entity (e.g., network node 110) may include a communication manager 150. As described in more detail elsewhere herein, the communication manager 150 may receive a first report that includes CSI feedback derived using an ML model under test. The communication manager 150 may receive a second report that includes a reference CSI and an indication of an accuracy of the reference CSI. The communication manager 150 may use the reference CSI for ML model monitoring based at least in part on the accuracy of the reference CSI. Additionally, or alternatively, the communication manager 150 may perform one or more other operations described herein.

As indicated above, FIG. 1 is provided as an example. Other examples may differ from what is described with regard to FIG. 1.

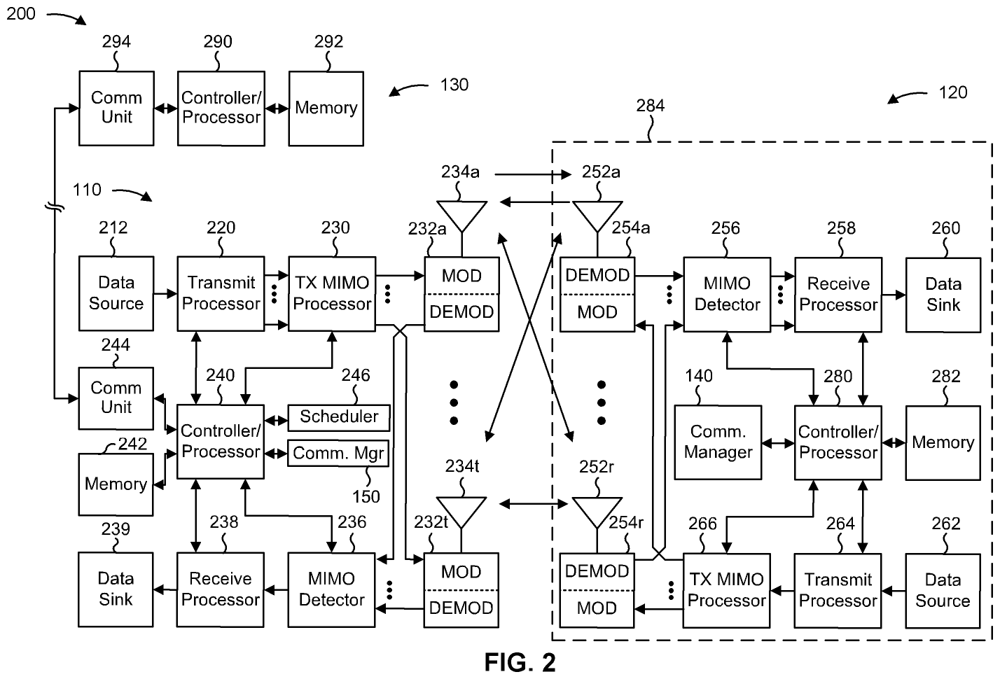

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

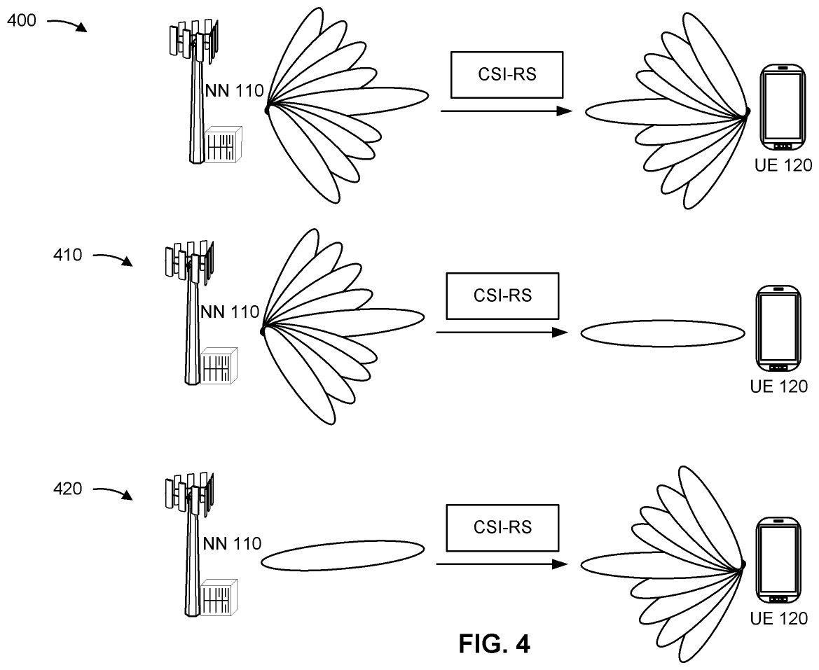

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

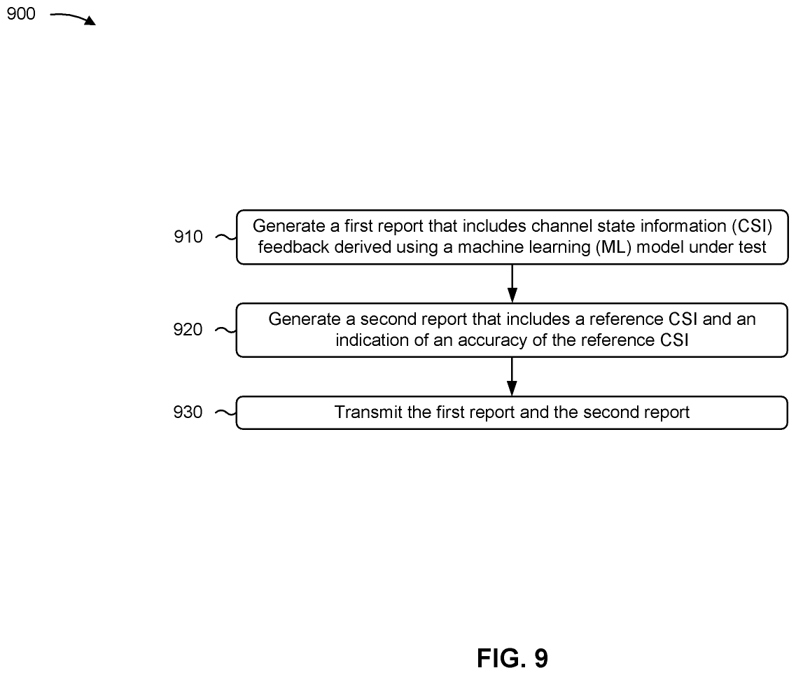

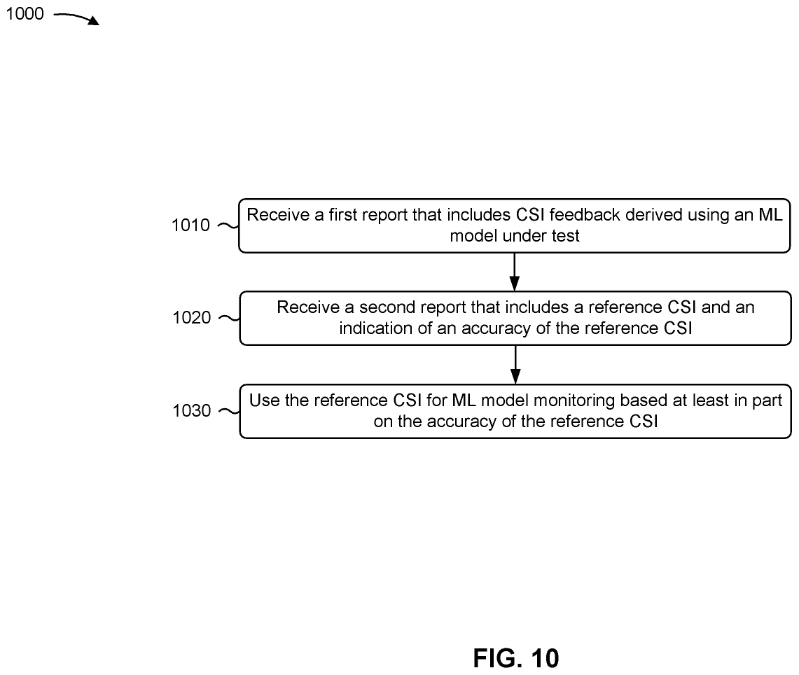

The controller/processor of a network entity (e.g., controller/processor 240 of the network node 110), the controller/processor 280 of the UE 120, and/or any other component(s) of FIG. 2 may perform one or more techniques associated with indicating an accuracy of a reference CSI, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., UE 120) includes means for generating a first report that includes CSI feedback derived using an ML model under test; means for generating a second report that includes a reference CSI and an indication of an accuracy of the reference CSI; and/or means for transmitting the first report and the second report. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., network node 110) includes means for receiving a first report that includes CSI feedback derived using an ML model under test; means for receiving a second report that includes a reference CSI and an indication of an accuracy of the reference CSI; and/or means for using the reference CSI for ML model monitoring based at least in part on the accuracy of the reference CSI. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

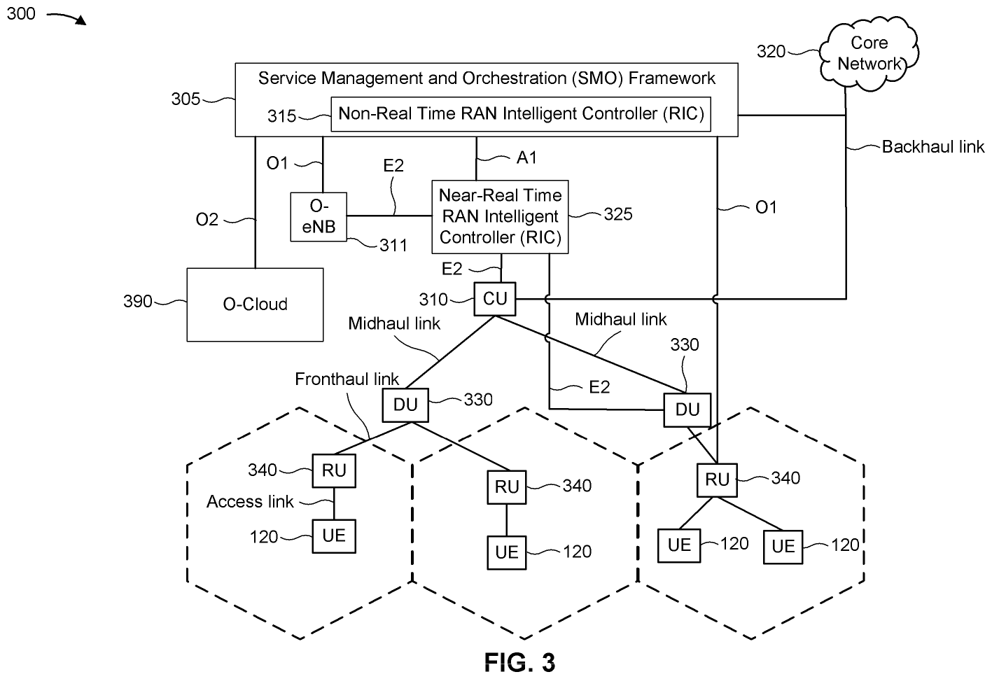

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325. In some examples, the near-RT RIC 325 may be a logical function that enables near-real-time control and optimization of O-RAN elements and resources via fine-grained data collection and actions over an E2 interface. The Near-RT RIC 325 may be collocated with the RAN or network entity to provide the real-time processing, such as online ML training or near real time ML inference. The non-RT RIC 315 may be a logical function that enables non-real-time control and optimization of RAN elements and resources, AI/ML workflow including model training and updates, and policy-based guidance of applications/features in near-RT RIC 325, as well as ML inference with less latency specification. The non-RT RIC 315 may be located further from the RAN or network node, such as on a cloud-based server or on an edge server.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400, 410, and 420 of beam management procedures, in accordance with the present disclosure. As shown in FIG. 4, examples 400, 410, and 420 include a UE 120 in communication with a network entity (e.g., network node 110) in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same reference signal resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same reference signal resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Wireless networks may operate at higher frequency bands, such as within millimeter wave (mmW) bands (e.g., FR2 above 28 GHz, FR4 above 60 GHz, or THz band above 100 GHz, among other examples), to offer high data rates. For example, wireless devices, such as a network node and a UE, may communicate with each other through beamforming techniques to increase communication speed and reliability. The beamforming techniques may enable a wireless device to transmit a signal toward a particular direction instead of transmitting an omnidirectional signal in all directions. In some examples, the wireless device may transmit a signal from multiple antenna elements using a common wavelength and phase for the transmission from the multiple antenna elements, and the signal from the multiple antenna elements may be combined to create a combined signal with a longer range and a more directed beam. The beamwidth of the signal may vary based on the transmitting frequency. For example, the width of a beam may be inversely related to the frequency, where the beamwidth may decrease as the transmitting frequency increases because more radiating elements may be placed per given area at a transmitter due to smaller wavelength. As a result, higher frequency bands (e.g., THz or sub-THz frequency bands) may enable wireless devices to form much narrower beam structures (e.g., pencil beams, laser beams, or narrow beams, among other examples) compared to the beam structures under the FR2 or below because more radiating elements may be placed per given area at the antenna element due to smaller wavelength. The higher frequency bands may have short delay spreads (e.g., few nanoseconds) and may be translated into coherence frequency bandwidths of tens (10s) of MHz. In addition, the higher frequency bands may provide a large available bandwidth, which may be occupied by larger bandwidth carriers, such as 1000 MHz per carrier or above. In some examples, the transmission path of a narrower beam may be more likely to be tailored to a receiver, such that the transmission may be more likely to meet a line-of-sight (LOS) condition as the narrower beam may be more likely to reach the receiver without being obstructed by obstacle(s). Also, as the transmission path may be narrow, reflection and/or refraction may be less likely to occur for the narrower beam.

While higher frequency bands may provide narrower beam structures and higher transmission rates, higher frequency bands may also encounter higher attenuation and diffraction losses, where a blockage of an LOS path may degrade a wireless link quality. For example, when two wireless devices are communicating with each other based on an LOS path at a higher frequency band and the LOS path is blocked by an obstacle, such as a pedestrian, building, and/or vehicle, among other examples, the received power may drop significantly. As a result, wireless communications based on higher frequency bands may be more susceptible to environmental changes compared to lower frequency bands. To ensure that the UE 120 and the network node 110 are communicating using a best beam or beam pair, beam management procedures (e.g., such as the beam management procedures described in connection with FIG. 4) may be performed by the UE 120 and/or the network node 110. However, because higher frequency bands may be more susceptible to environmental changes compared to lower frequency bands, the beam management procedures may need to be performed more frequently and/or using additional beams. This may introduce significant overhead and consume network resources, processing resources, and/or power resources of a UE (and/or a network node) associated with performing the beam management procedures.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

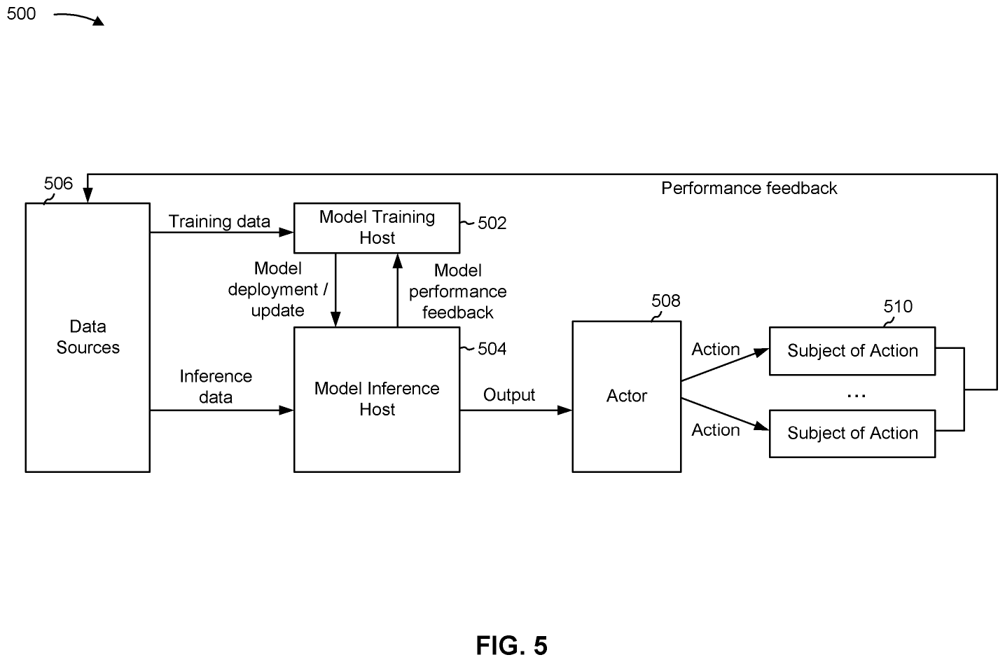

FIG. 5 is a diagram illustrating an example architecture 500 for performance monitoring of ML models, in accordance with the present disclosure. For example, the architecture 500 may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, a network entity, a base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with beam management, the actor 508 may be a UE, a DU or an RU; whereas if the output from the model inference host 504 is associated with Tx/Rx scheduling, the actor 508 may be a CU or a DU.

After the actor 508 receives an output from the model inference host 504, the actor 508 may determine whether to act based on the output. For example, if the actor 508 is a DU or an RU and the output from the model inference host 504 is associated with beam management, the actor 508 may determine whether to change/modify a Tx/Rx beam based on the output. If the actor 508 determines to act based on the output, the actor 508 may indicate the action to at least one subject of action 510. For example, if the actor 508 determines to change/modify a Tx/Rx beam for a communication between the actor 508 and the subject of action 510 (e.g., a UE 120), then the actor 508 may transmit a beam (re-)configuration or a beam switching indication to the subject of action 510. The actor 508 may modify its Tx/Rx beam based on the beam (re-)configuration, such as switching to a new Tx/Rx beam or applying different parameters for a Tx/Rx beam, among other examples. As another example, the actor 508 may be a UE, and the output from the model inference host 504 may be associated with beam management. For example, the output may be one or more predicted measurement values for one or more beams. The actor 508 (e.g., a UE) may determine that a measurement report (e.g., a Layer 1 (L1) RSRP report) is to be transmitted to a network node 110.

The data sources 506 may also be configured for collecting data that is used as training data for training an ML model or as inference data for feeding an ML model inference operation. For example, the data sources 506 may collect data from one or more core network and/or RAN entities, which may include the subject of action 510, and provide the collected data to the model training host 502 for ML model training. For example, after a subject of action 510 (e.g., a UE 120) receives a beam configuration from the actor 508, the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

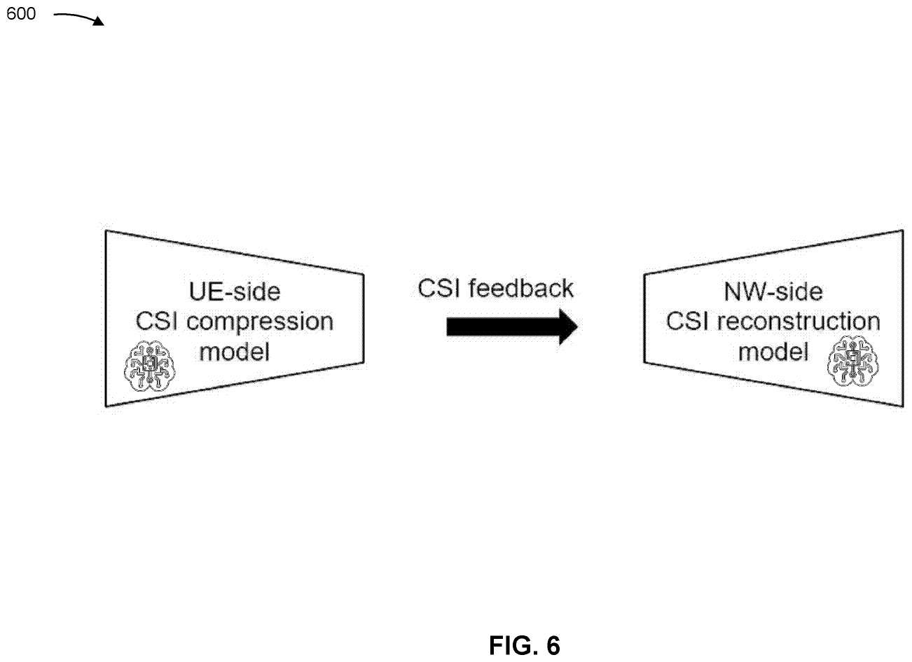

FIG. 6 is a diagram illustrating an example 600 of CSI compression and reconstruction models, in accordance with the present disclosure.

With an AI/ML-based air interface, a UE and a network entity (e.g., gNB) may use trained AI/ML models for CSI feedback. For example, if the UE intends to convey CSI to the network entity, the UE may use an ML model (e.g., neural network) to derive a compressed representation of the CSI to feed back to the network entity. The network entity may use another ML model to reconstruct the target CSI (e.g., actual CSI, ground truth) from the compressed representation.

For the reconstruction to be accurate, the UE-side and network (NW)-side ML models are trained in a collaborative manner so that the compressed representation created by the UE-side model is interpreted and decoded correctly by the NW-side model. If this requirement is satisfied, then such a pair of models is said to be compatible with each other.

A goal of ML model monitoring is to identify cases where the reconstructed CSI is very different from the target CSI that the UE intended to convey. To determine whether the ML models are performing well, the reconstructed CSI on the NW-side is compared with the target CSI on the UE side. The UE may convey the target CSI using separate signaling, which would introduce more signaling overhead, especially if the target CSI has to be conveyed with high resolution

An alternate option is for the UE to convey, as a reference CSI, another compressed version of the target CSI to the gNB in the form of a CSI feedback message using a second (reference) CSI feedback scheme, such as a non-AI/ML scheme or using a Type II CSI feedback. An AI/ML scheme that uses a reference AI/ML model whose performance is expected to be adequate in a larger set of scenarios. The network entity may compare the CSI reconstructed using the ML model under test, with the reference CSI sent by the UE using the second CSI feedback scheme. The second CSI feedback scheme may be more trustworthy and more complex. The second CSI feedback scheme may involve the transmission of reference CSIs less frequently than the transmission of actual CSIs or target CSIs.

For this approach to work, the reference CSI is assumed to be a good approximation of the target CSI and thus the reference CSI can be used in place of the target CSI for the purpose of ML model monitoring comparisons. However, this assumption may not always hold, and the reference CSI may not be close to the target CSI. Using inaccurate CSI for ML model performance monitoring can lead to degraded communications and wasted power, processing resources, and signaling resources.

As indicated above, FIG. 6 is provided as an example. Other examples may differ from what is described with regard to FIG. 6.

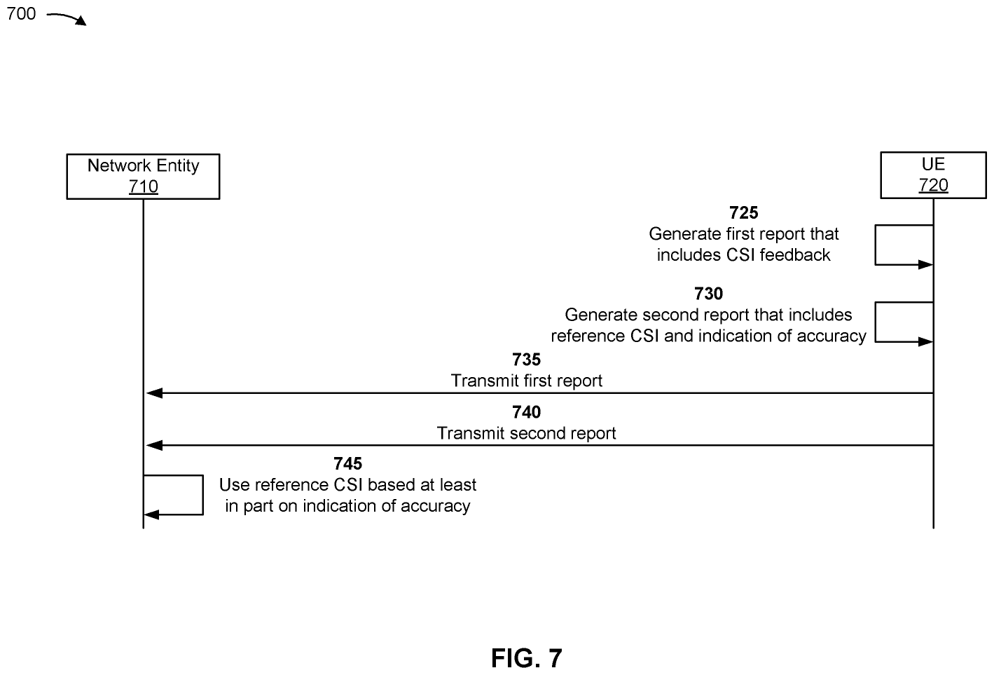

FIG. 7 is a diagram illustrating an example 700 associated with indicating an accuracy of a reference CSI, in accordance with the present disclosure. As shown in FIG. 7, a network entity 710 (e.g., network node 110) and a UE 720 (e.g., UE 120) may communicate with one another via a wireless network (e.g., wireless network 100).

According to various aspects described herein, the UE 720 may transmit an indication of the accuracy of a reference CSI. The indication of the accuracy may indicate how close the reference CSI is to the target CSI. For example, if the CSI is in the form of a precoding vector, the indication may be based at least in part on a comparison metric between the two precoding vectors, such as cosine similarity metrics and/or spectral efficiency estimates. A cosine similarity metric may be a measure of similarity between two precoding vectors and may involve a cosine angle of difference between the two precoding vectors. Cosine similarity metrics may include a generalized cosine similarity (GCS) or an average square generalized cosine similarity (SGCS).

In some aspects, the indication of the accuracy may be for a specific time instance or a specific request. In some aspects, the indication of the accuracy may be over a period of time and may be an average accuracy of the period of time.

In some aspects, the UE 720 may transmit the reference CSI based at least in part on an accuracy threshold. For example, if the calculated accuracy or comparison of the reference CSI with the target CSI satisfies the accuracy threshold (e.g., accuracy percentage equal to or greater than a percentage threshold), the UE 720 may transmit the reference CSI. If the calculated accuracy or comparison of the reference CSI with the actual CSI or target CSI does not satisfy the accuracy threshold (e.g., accuracy percentage is less than the percentage threshold), the UE 720 may refrain from transmitting the reference CSI. The UE 720 may receive a configuration that indicates the accuracy threshold.

Example 700 shows indication of the accuracy of a reference CSI. As shown by reference number 725, the UE 720 may generate a first report that includes CSI feedback derived from an ML model under test. The CSI feedback may be compressed CSI feedback that is compressed using an ML model for compressing CSI. The ML model is considered under test because the performance of the model is being evaluated. As shown by reference number 730, the UE 720 may generate a second report that includes the reference CSI and an indication of the accuracy of the reference CSI. As shown by reference number 735, the UE 720 may transmit the first report. As shown by reference number 740, the UE 720 may transmit the second report. The UE 720 may transmit reports of the second type (e.g., reference CSIs) less frequently than reports of the first type (e.g., CSI feedback).

The network entity 710 may receive the reports. As shown by reference number 745, the network entity 710 may use the reference based at least in part on the accuracy indicated by the second report. The network entity 710 may use the indication of the accuracy of the reference CSI to determine whether the reference CSI can be relied upon as a benchmark for comparison or whether the reference CSI is not a good approximation of the target CSI. If the network entity 710 decides to use the reference CSI as a benchmark, the network entity 710 may compare the reference CSI and the reconstructed CSI based at least in part on the reference CSI's reported accuracy metric (e.g., thresholds used in the comparison process may be decided based on the reported accuracy). The comparison may indicate if the ML model of compression and/or the ML model for decompression is working (e.g., accurate reconstruction), is degrading towards failure, or is failing.

In some aspects, the network entity 710 may use the reference CSI based at least in part on an accuracy threshold (same or different than the threshold used by the UE 720). For example, if the indicated accuracy satisfies the accuracy threshold (e.g., accuracy percentage equal to or greater than a percentage threshold), the network entity 710 may use the reference CSI for ML model monitoring. This may include adjusting parameters or an architecture of an ML model for compression or reconstruction. If the indicated accuracy does not satisfy the accuracy threshold (e.g., accuracy percentage is less than the percentage threshold), the network entity 710 may refrain from using the reference CSI.

In some aspects, even if the indicated accuracy does not satisfy a particular accuracy threshold, the network entity 710 may use the reference CSI to adjust a threshold (e.g., relax or lower a criterion) that is used to determine whether an ML model is working or failing. This may prevent premature failure when conditions do not provide for an optimal ML model.

By indicating the accuracy of the reference CSI, the UE 720 may help the network entity 710 to have more accurate ML models for CSI reconstruction and decoding, which may improve communications while limiting overhead with the less frequent transmission of reference CSI. Improved communications conserve power, processing resources, and signaling resources that are otherwise wasted by degraded communications and retransmissions.

As indicated above, FIG. 7 is provided as an example. Other examples may differ from what is described with regard to FIG. 7.

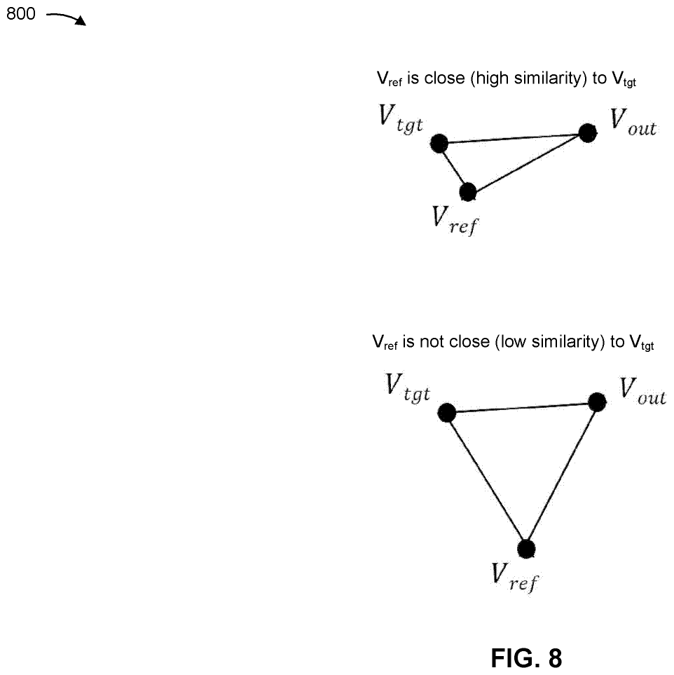

FIG. 8 is a diagram illustrating an example 800 of precoding vector similarities, in accordance with the present disclosure.

A reference CSI precoding vector (V_{ref}) may be compared to a target CSI precoding vector (V_{tgt}). Vₒᵤₜ may represent a reconstructed CSI precoding vector that is output from the NW-side model. An accuracy of V_{ref} may be indicated by a similarity metric, such as a SGCS. For example, a first cosine similarity metric x₁ may be for a relationship between V_{tgt} and Vₒᵤₜ and represented as SGCS(V_{tgt}, Vₒᵤₜ). A second cosine similarity metric x₂ may be for a relationship between V_{ref} and Vₒᵤₜ and represented as SGCS(V_{ref}, Vₒᵤₜ). A third cosine similarity metric x₃ may be for a relationship between V_{ref} and V_{tgt} and represented as SGCS(V_{ref}, V_{tgt}).

Example 800 shows that V_{ref} and V_{tgt} may have a high similarity (close) for x₃ or a low similarity for x₃. If x₃ is large (high similarity), the network entity 710 may use V_{ref} as the benchmark in place of V_{tgt}. If x₃ is small (low similarity), the network entity 710 may not use V_{ref} as the benchmark in place of V_{tgt}.

In sum, one approach to avoid the overhead of signaling the target CSI at high resolution is to use a reference CSI in its place as the benchmark for comparison. By indicating the accuracy of the reference CSI, the network entity's use of the reference CSI is more robust, and the network entity may determine whether a reference CSI is reliable enough to be used as the benchmark. This reduces the false alarm probability for the ML model monitoring process. As a result, premature ML model failure or extended use of a failing ML model are avoided and power, processing resources, and signaling resources are conserved.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120, UE 720) performs operations associated with indicating the accuracy of a reference CSI.

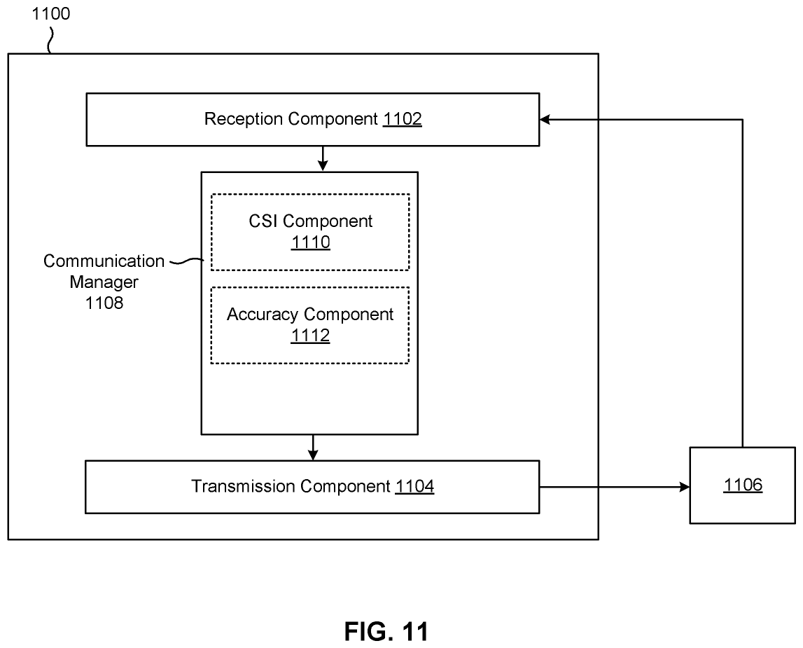

As shown in FIG. 9, in some aspects, process 900 may include generating a first report that includes CSI feedback derived using an ML model under test (block 910). For example, the UE (e.g., using communication manager 1108 and/or CSI component 1110 depicted in FIG. 11) may generate a first report that includes CSI feedback derived using an ML model under test, as described above in connection with FIGS. 5-8.

As shown in FIG. 9, in some aspects, process 900 may include generating a second report that includes a reference CSI and an indication of the accuracy of the reference CSI (block 920). For example, the UE (e.g., using communication manager 1108 and/or accuracy component 1112 depicted in FIG. 11) may generate a second report that includes a reference CSI and an indication of the accuracy of the reference CSI, as described above in connection with FIGS. 5-8.

As further shown in FIG. 9, in some aspects, process 900 may include transmitting the first report and the second report (block 930). For example, the UE (e.g., using communication manager 1108 and/or transmission component 1104 depicted in FIG. 11) may transmit the first report and the second report, as described above in connection with FIGS. 5-8.

Process 900 may include additional aspects, such as any single aspect or any combination of aspects described below and/or in connection with one or more other processes described elsewhere herein.

In a first aspect, the reference CSI is associated with a CSI reporting scheme that is different than a CSI reporting scheme that uses the ML model under test. In some aspects, the reference CSI is associated with a non-AI/ML CSI reporting scheme, such as Type II or enhanced Type II (eType II).

In a second aspect, alone or in combination with the first aspect, transmitting the report includes transmitting CSI references less frequently than CSI feedback.

In a third aspect, alone or in combination with one or more of the first and second aspects, transmitting the second report includes transmitting the second report based at least in part on an accuracy threshold.

In a fourth aspect, alone or in combination with one or more of the first through third aspects, transmitting the second report based at least in part on the accuracy threshold includes transmitting the second report based at least in part on the accuracy satisfying an accuracy threshold.

In a fifth aspect, alone or in combination with one or more of the first through fourth aspects, transmitting the second report based at least in part on the accuracy threshold includes refraining from transmitting the second report based at least in part on the accuracy not satisfying an accuracy threshold.

In a sixth aspect, alone or in combination with one or more of the first through fifth aspects, process 900 includes receiving a configuration that indicates the accuracy threshold.

In a seventh aspect, alone or in combination with one or more of the first through sixth aspects, the indication of the accuracy of the reference CSI indicates how close the reference CSI is to a target CSI.

In an eighth aspect, alone or in combination with one or more of the first through seventh aspects, the indication of the accuracy is or is based at least in part on a cosine similarity metric between the reference CSI and the target CSI.

In a ninth aspect, alone or in combination with one or more of the first through eighth aspects, the indication of the accuracy is or is based at least part on a spectral efficiency estimate.

In a tenth aspect, alone or in combination with one or more of the first through ninth aspects, the accuracy is specific to a time instance associated with a request.

In an eleventh aspect, alone or in combination with one or more of the first through tenth aspects, process 900 includes determining the accuracy over a period of time.

In a twelfth aspect, alone or in combination with one or more of the first through eleventh aspects, the accuracy is an average of multiple accuracy calculations over the period of time.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., network node 110, network entity 710) performs operations associated with using an indication of the accuracy of a reference CSI.

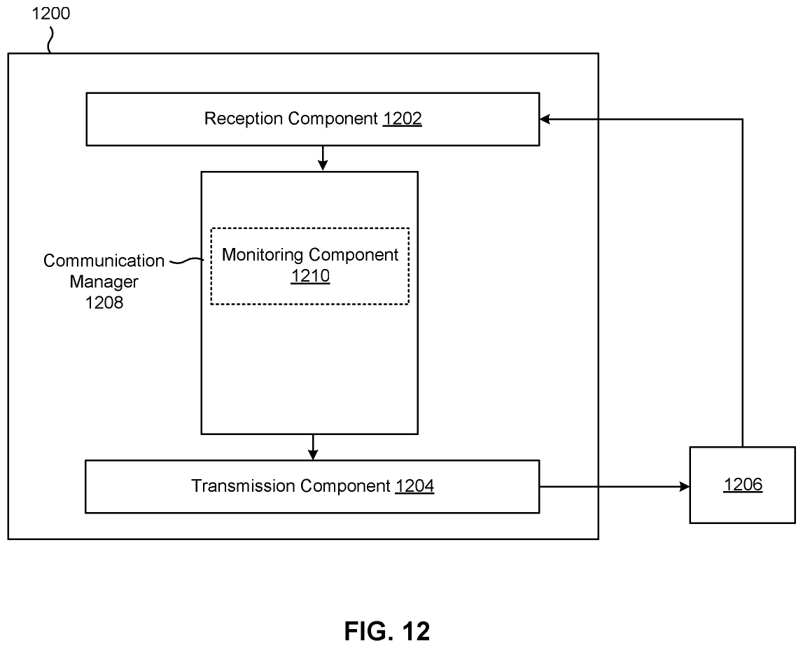

As shown in FIG. 10, in some aspects, process 1000 may include receiving a first report that includes CSI feedback derived using a ML model under test (block 1010). For example, the network entity (e.g., using communication manager 1208 and/or reception component 1202 depicted in FIG. 12) may receive a first report that includes CSI feedback derived using a ML model under test, as described above in connection with FIGS. 5-8.

As shown in FIG. 10, in some aspects, process 1000 may include receiving a second report that includes a reference CSI and an indication of the accuracy of the reference CSI (block 1020). For example, the network entity (e.g., using communication manager 1208 and/or reception component 1202 depicted in FIG. 12) may receive a second report that includes a reference CSI and an indication of the accuracy of the reference CSI, as described above in connection with FIGS. 5-8.

As further shown in FIG. 10, in some aspects, process 1000 may include using the reference CSI for ML model monitoring based at least in part on the accuracy of the reference CSI (block 1030). For example, the network entity (e.g., using communication manager 1208 and/or monitoring component 1210 depicted in FIG. 12) may use the reference CSI for ML model monitoring based at least in part on the accuracy of the reference CSI, as described above in connection with FIGS. 5-8.

Process 1000 may include additional aspects, such as any single aspect or any combination of aspects described below and/or in connection with one or more other processes described elsewhere herein.

In a first aspect, the reference CSI is associated with a CSI reporting scheme that is different than a CSI reporting scheme that uses the ML model under test. In some aspects, the reference CSI is associated with a non-AI/ML CSI reporting scheme.

In a second aspect, alone or in combination with the first aspect, process 1000 includes receiving reports of a type of the second report less frequently than reports of a type of the first report.

In a third aspect, alone or in combination with one or more of the first and second aspects, using the reference CSI for ML model monitoring based at least in part on the accuracy of the reference CSI includes using the reference CSI for ML model monitoring based at least in part on the accuracy of the reference CSI satisfying an accuracy threshold.

In a fourth aspect, alone or in combination with one or more of the first through third aspects, using the reference CSI for ML model monitoring based at least in part on the accuracy of the reference CSI includes refraining from using the reference CSI for ML model monitoring based at least in part on the accuracy of the reference CSI not satisfying an accuracy threshold.

In a fifth aspect, alone or in combination with one or more of the first through fourth aspects, using the reference CSI for ML model monitoring based at least in part on the accuracy of the reference CSI includes adjusting a criterion for monitoring CSI ML model performance based at least in part on the accuracy of the reference CSI not satisfying an accuracy threshold.

In a sixth aspect, alone or in combination with one or more of the first through fifth aspects, process 1000 includes transmitting a configuration that indicates an accuracy threshold.

In a seventh aspect, alone or in combination with one or more of the first through sixth aspects, the indication of the accuracy of the reference CSI indicates how close the reference CSI is to a target CSI.

In an eighth aspect, alone or in combination with one or more of the first through seventh aspects, the indication of the accuracy is or is based at least in part on a cosine similarity metric between the reference CSI and the target CSI.

In a ninth aspect, alone or in combination with one or more of the first through eighth aspects, the indication of the accuracy is or is based at least in part on a spectral efficiency estimate.

In a tenth aspect, alone or in combination with one or more of the first through ninth aspects, the accuracy is specific to a time instance associated with a request, and process 1000 includes transmitting the request.

In an eleventh aspect, alone or in combination with one or more of the first through tenth aspects, the accuracy is an average of multiple accuracy calculations over a period of time.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE (e.g., UE 120, UE 720), or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 1108 may control and/or otherwise manage one or more operations of the reception component 1102 and/or the transmission component 1104. In some aspects, the communication manager 1108 may include one or more antennas, a modem, a controller/processor, a memory, or a combination thereof, of the UE described in connection with FIG. 2. The communication manager 1108 may be, or be similar to, the communication manager 140 depicted in FIGS. 1 and 2. For example, in some aspects, the communication manager 1108 may be configured to perform one or more of the functions described as being performed by the communication manager 140. In some aspects, the communication manager 1108 may include the reception component 1102 and/or the transmission component 1104. The communication manager 1108 may include a CSI component 1110 and/or an accuracy component 1112, among other examples.

In some aspects, the apparatus 1100 may be configured to perform one or more operations described herein in connection with FIGS. 1-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The CSI component 1110 may generate a first report that includes CSI feedback derived using an ML model under test. The accuracy component 1112 may generate a second report that includes a reference CSI and an indication of an accuracy of the reference CSI. The transmission component 1104 may transmit the first report and the second report. The reception component 1102 may receive a configuration that indicates the accuracy threshold. The accuracy component 1112 may determine the accuracy over a period of time.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network entity (e.g., network node 110, network entity 710), or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208. The communication manager 1208 may control and/or otherwise manage one or more operations of the reception component 1202 and/or the transmission component 1204. In some aspects, the communication manager 1208 may include one or more antennas, a modem, a controller/processor, a memory, or a combination thereof, of the network entity described in connection with FIG. 2. The communication manager 1208 may be, or be similar to, the communication manager 150 depicted in FIGS. 1 and 2. For example, in some aspects, the communication manager 1208 may be configured to perform one or more of the functions described as being performed by the communication manager 150. In some aspects, the communication manager 1208 may include the reception component 1202 and/or the transmission component 1204. The communication manager 1208 may include a monitoring component 1210, among other examples.

In some aspects, the apparatus 1200 may be configured to perform one or more operations described herein in connection with FIGS. 1-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The reception component 1202 may receive a first report that includes CSI feedback derived using an ML model under test. The reception component 1202 may receive a second report that includes a reference CSI and an indication of an accuracy of the reference CSI. The monitoring component 1210 may use the reference CSI for ML model monitoring based at least in part on the accuracy of the reference CSI. The transmission component 1204 may transmit a configuration that indicates an accuracy threshold.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: generating a first report that includes channel state information (CSI) feedback derived using a machine learning (ML) model under test; generating a second report that includes a reference CSI and an indication of an accuracy of the reference CSI; and transmitting the first report and the second report.

Aspect 2: The method of Aspect 1, wherein the reference CSI is associated with a CSI reporting scheme that is different than a CSI reporting scheme that uses the ML model under test.

Aspect 3: The method of any of Aspects 1-2, wherein the reference CSI is associated with a non-ML CSI reporting scheme.

Aspect 4: The method of any of Aspects 1-3, further comprising transmitting CSI references less frequently than CSI feedback.

Aspect 5: The method of any of Aspects 1-4, wherein transmitting the second report includes transmitting the second report based at least in part on an accuracy threshold.

Aspect 6: The method of Aspect 5, wherein transmitting the second report based at least in part on the accuracy threshold includes transmitting the second report based at least in part on the accuracy satisfying an accuracy threshold.

Aspect 7: The method of Aspect 5, wherein transmitting the second report based at least in part on the accuracy threshold includes refraining from transmitting the second report based at least in part on the accuracy not satisfying an accuracy threshold.

Aspect 8: The method of any of Aspects 5-7, further comprising receiving a configuration that indicates the accuracy threshold.

Aspect 9: The method of any of Aspects 1-8, wherein the indication of the accuracy of the reference CSI indicates how close the reference CSI is to a target CSI.

Aspect 10: The method of Aspect 9, wherein the indication of the accuracy is based at least in part on a cosine similarity metric between the reference CSI and the target CSI.

Aspect 11: The method of Aspect 9 or 10, wherein the indication of the accuracy is based at least in part on a spectral efficiency estimate.

Aspect 12: The method of any of Aspects 1-11, wherein the accuracy is specific to a time instance associated with a request.

Aspect 13: The method of any of Aspects 1-12, further comprising determining the accuracy over a period of time.

Aspect 14: The method of Aspect 13, wherein the accuracy is an average of multiple accuracy calculations over the period of time.

Aspect 15: A method of wireless communication performed by a network entity, comprising: receiving a first report that includes channel state information (CSI) feedback derived using a machine learning (ML) model under test; receiving a second report that includes a reference CSI and an indication of an accuracy of the reference CSI; and using the reference CSI for ML model monitoring based at least in part on the accuracy of the reference CSI.

Aspect 16: The method of Aspect 15, wherein the reference CSI is associated with a CSI reporting scheme that is different than a CSI reporting scheme that uses the ML model under test.

Aspect 17: The method of any of Aspects 15-16, wherein receiving the report includes receiving the report less frequently than a target CSI.

Aspect 18: The method of any of Aspects 15-17, wherein the reference CSI is associated with a non-ML CSI reporting scheme.

Aspect 19: The method of any of Aspects 15-18, wherein using the reference CSI for ML model monitoring based at least in part on the accuracy of the reference CSI includes using the reference CSI for ML model monitoring based at least in part on the accuracy of the reference CSI satisfying an accuracy threshold.

Aspect 20: The method of any of Aspects 15-19, wherein using the reference CSI for ML model monitoring based at least in part on the accuracy of the reference CSI includes refraining from using the reference CSI for ML model monitoring based at least in part on the accuracy of the reference CSI not satisfying an accuracy threshold.

Aspect 21: The method of any of Aspects 15-20, wherein using the reference CSI for ML model monitoring based at least in part on the accuracy of the reference CSI includes adjusting a criterion for monitoring CSI ML model performance based at least in part on the accuracy of the reference CSI not satisfying an accuracy threshold.

Aspect 22: The method of any of Aspects 15-21, further comprising transmitting a configuration that indicates an accuracy threshold.

Aspect 23: The method of any of Aspects 15-22, wherein the indication of the accuracy of the reference CSI indicates how close the reference CSI is to a target CSI.

Aspect 24: The method of Aspect 23, wherein the indication of the accuracy is based at least in part on a cosine similarity metric between the reference CSI and the target CSI.

Aspect 25: The method of Aspect 23 or 24, wherein the indication of the accuracy is based at least in part on a spectral efficiency estimate.

Aspect 26: The method of any of Aspects 16-25, wherein the accuracy is specific to a time instance associated with a request, and wherein the method includes transmitting the request.

Aspect 27: The method of any of Aspects 15-26, wherein the accuracy is an average of multiple accuracy calculations over a period of time.

Aspect 28: An apparatus for wireless communication at a device, comprising a processor; memory coupled with the processor; and instructions stored in the memory and executable by the processor to cause the apparatus to perform the method of one or more of Aspects 1-27.

Aspect 29: A device for wireless communication, comprising a memory and one or more processors coupled to the memory, the one or more processors configured to perform the method of one or more of Aspects 1-27.

Aspect 30: An apparatus for wireless communication, comprising at least one means for performing the method of one or more of Aspects 1-27.

Aspect 31: A non-transitory computer-readable medium storing code for wireless communication, the code comprising instructions executable by a processor to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
generate a first report that includes channel state information (CSI) feedback derived using a machine learning (ML) model under test;
generate a second report that includes a reference CSI associated with the CSI feedback and an indication of an accuracy of the reference CSI; and
transmit the first report and the second report.

2. The UE of claim 1, wherein the reference CSI is associated with a CSI reporting scheme that is different than a CSI reporting scheme that uses the ML model under test.

3. The UE of claim 1, wherein the reference CSI is associated with a non-ML CSI reporting scheme.

4. The UE of claim 1, wherein the one or more processors are configured to transmit CSI references less frequently than CSI feedback.

5. The UE of claim 1, wherein the one or more processors, to transmit the second report, are configured to transmit the second report based at least in part on an accuracy threshold.

6. The UE of claim 5, wherein the one or more processors, to transmit the second report based at least in part on the accuracy threshold, are configured to transmit the second report based at least in part on the accuracy satisfying an accuracy threshold.

7. The UE of claim 5, wherein the one or more processors, to transmit the second report based at least in part on the accuracy threshold, are configured to refrain from transmitting the second report based at least in part on the accuracy not satisfying an accuracy threshold.

8. The UE of claim 5, wherein the one or more processors are configured to receive a configuration that indicates the accuracy threshold.

9. The UE of claim 1, wherein the indication of the accuracy of the reference CSI indicates how close the reference CSI is to a target CSI.

10. The UE of claim 1, wherein the indication of the accuracy is based at least in part on a cosine similarity metric between the reference CSI and the target CSI.

11. The UE of claim 1, wherein the indication of the accuracy is based at least in part on a spectral efficiency estimate.

12. The UE of claim 1, wherein the accuracy is specific to a time instance associated with a request.

13. The UE of claim 1, wherein the one or more processors are configured to determine the accuracy over a period of time.

14. The UE of claim 13, wherein the accuracy is an average of multiple accuracy calculations over the period of time.

15. A network entity for wireless communication, comprising:
a memory; and
one or more processors, coupled to the memory, configured to:
receive a first report that includes channel state information (CSI) feedback derived using a machine learning (ML) model under test;
receive a second report that includes a reference CSI and an indication of an accuracy of the reference CSI; and
use the reference CSI for ML model monitoring based at least in part on the accuracy of the reference CSI.

16. The network entity of claim 15, wherein the reference CSI is associated with a CSI reporting scheme that is different than a CSI reporting scheme that uses the ML model under test.

17. The network entity of claim 15, wherein the reference CSI is associated with a non-ML CSI reporting scheme.

18. The network entity of claim 15, wherein the one or more processors, to use the reference CSI for ML model monitoring based at least in part on the accuracy of the reference CSI, are configured to use the reference CSI for ML model monitoring based at least in part on the accuracy of the reference CSI satisfying an accuracy threshold.

19. The network entity of claim 15, wherein the one or more processors, to use the reference CSI for ML model monitoring based at least in part on the accuracy of the reference CSI, are configured to refrain from using the reference CSI for ML model monitoring based at least in part on the accuracy of the reference CSI not satisfying an accuracy threshold.

20-25. (canceled)

26. A method of wireless communication performed by a user equipment (UE), comprising:
generating a first report that includes channel state information (CSI) feedback derived using a machine learning (ML) model under test;
generating a second report that includes a reference CSI and an indication of an accuracy of the reference CSI; and
transmitting the first report and the second report.

27-30. (canceled)
